(19) United States
(12) Patent Application Publication
(10) Pub. No.: US 2012/0028853 A1
(43) Pub. Date: Feb. 2, 2012

(54) DRILLING FLUID, DRILLING FLUID ADDITIVE, METHODS OF MAKING AND USING, SUCH FLUID AND ADDITIVE, METHODS OF OPERATING A WELL

(76) Inventor: JAMES D. MASIKEWICH, Calgary (CA)

(21) Appl. No.: 12/843,929

(22) Filed: Jul. 27, 2010

(51) Int. Cl. C09K 8/08; C09K 8/68

(52) U.S. Cl. 507/110; 507/209

(57) ABSTRACT

Well fluids and well fluid additives comprising a blend of guar gums of various viscosities, methods of making and using such fluids and additives, and methods of operating a well using such fluids and/or additives.

### RELATED APPLICATION DATA

This application claims priority from U.S. Provisional Patent Application No. 61/228,969, filed Jul. 27, 2009, which is incorporated herein by reference.

### BACKGROUND OF THE INVENTION

1. Field of the Invention

The present invention relates to well fluids, well fluid additives, methods of making and using well fluids and well fluid additives, and methods of operating a well. In another aspect, the present invention relates to well fluids comprising guar, well fluid additives comprising guar, methods of making and using well fluids and additives comprising guar, and methods of operating a well using well fluids comprising guar. In even another aspect, the present invention relates to well fluids comprising two or more guar compounds, well fluid additives comprising two or more guar compounds, methods of making and using well fluids and additives comprising two or more guar compounds, and methods of operating a well using well fluids comprising two or more guar compounds. In still another aspect, the present invention relates to well fluids comprising two or more guar compounds having different viscosities, well fluid additives comprising two or more guar compounds having different viscosities, methods of making and using well fluids and additives comprising two or more guar compounds having different viscosities, and methods of operating a well using well fluids comprising two or more guar compounds having different viscosities.

2. Brief Description of the Related Art

Conventional shallow wells are drilled with water under the surface shoe. The drilling mud is made thicker at a point known as the mud-up to protect the production zone and facilitate running electric logs and running casing. Usually this point occurs at a few hundred meters before the total depth of the well is reached. A typical shallow well is drilled within 48 hours. Inefficient mixing and time do not permit attaining an efficient mix or the cost effective optimization of properties.

To make the mud thicker a bentonite product such as Wyoming Bentonite, is added to the water. Other chemicals added may include a fluid loss reducer such as a starch or polyanionic cellulose such as Drispac, pH control such as caustic or citric acid and mud ring control such as sodium pyrophosphate. Due to time constraints in drilling the well and inefficient mixing, the chemicals added rarely have enough time to properly yield. This means that to obtain the desired properties of the mud system, over treatment of the chemicals into the drilling fluid system is often the norm.

A number of prior art patents and publications disclose the use of guar or xanthan gums in drilling fluids.

U.S. Pat. No. 4,105,461, issued Aug. 8, 1978, to Racciato, discloses thickening compositions containing xanthan gum, guar gum and starch. A blend of xanthan gum, guar gum, or guar gum derivatives, a starch ether has unique thickening properties. The blend is particularly useful in printing pastes, salad dressings and oil well drilling muds.

U.S. Pat. No. 4,425,241, issued Jan. 10, 1984, to Swanson, discloses polyethylene glycols in combination with at least one water-dispersible polymeric viscosifier comprising cellulose ethers, cellulose sulfate esters, polyacrylamides, guar gum, or heteropolysaccharides improve the water loss properties of water-based drilling fluids, particularly in hard brine environments.

U.S. Pat. No. 4,524,003, issued Jun. 18, 1985, to Borchardt, discloses a method of viscosifying aqueous fluids and process for recovery of hydrocarbons from subterranean formations. The present invention relates to a method of viscosifying aqueous fluids and a viscosifying composition which when admixed with an aqueous fluid produces a viscosity increase in the fluid in excess of the additive viscosity of the individual composition components. The viscosifying composition comprises at least one member selected from the group consisting of (i) sulfonated guar and a compound comprising at least one member selected from the group consisting of xanthan gum, guar, hydroxypropyl guar, hydroxypropyl guar derivatives, hydroxyethyl cellulose and hydroxyethyl cellulose derivatives and (ii) cationic guar and a compound comprising at least one member selected from the group consisting of hydroxypropyl guar, hydroxypropyl guar derivatives, hydroxyethyl cellulose and hydroxyethyl cellulose derivatives.

U.S. Pat. No. 5,576,271, issued Nov. 19, 1996, to Patel, discloses a composition and process for stabilizing viscosity or controlling water loss of polymer-containing water based fluids. A composition useful for viscosifying a water-based fluid is provided which comprises a polymer such as guar gum, a metal compound such as an aluminum compound. The composition can also contain a polymer such as guar gum, a magnesium compound such as magnesium oxide, a metal aluminate such as sodium aluminate or a metal compound such as an aluminum compound, and optionally a fatty acid or salts thereof. The water-based fluid can also contain a clay such as bentonite. A process for viscosifying a water-based fluid and for substantially retaining the viscosity of the water-based fluid is also provided which comprises contacting the fluid with the composition described herein. Also disclosed is a process for controlling water loss of a water-based drilling fluid wherein the process comprises contacting the fluid with the composition described herein.

U.S. Pat. No. 5,591,699, issued Jan. 7, 1997, to Hodge, discloses particle transport fluids thickened with acetylate free xanthan heteropolysaccharide biopolymer plus guar gum. A non-acetylated but otherwise unmodified xanthan heteropolysaccharide polymer plus guar gum, is employed to impart viscosity to an aqueous particle transport fluid (such as a drilling fluid, a fracturing fluid, or a filter structure emplacement fluid) sufficient to suspend mineral particles. A cross linking agent can also be employed to decrease the amounts of xanthan heteropolysaccharide polymer and guar gum which are needed for particle suspension.

U.S. Pat. No. 5,720,347, issued Feb. 24, 1998, to Audibert, et al., discloses a process and water-base fluid utilizing hydrophobically modified guars as filtrate reducers. In well drilling, well completion, or well workover, the permeability of the walls is controlled by adding a predetermined amount of at least one hydrophobically modified guar gum derivative, e.g., a hydrophobically modified hydroxypropyl guar (HMPG), so as to reduce the amount of filtrate lost through the walls. The fluid may also include viscosifiers such as polymers or reactive clay.

U.S. Pat. No. 6,620,769, issued Sep. 16, 2003, to Juppe, et al., discloses environmentally acceptable fluid polymer suspension for oil field services. This invention provides a water-free oil based fluid polymer suspension composition for use as a rheology modifier and fluid loss reducer in oil or gas well servicing fluids. It has been found that by using white medicinal oil as a carrier, high solids content and environmental friendly anhydrous fluidized polymer suspensions of xanthan gum, cellulose ethers, guar gum and derivatives thereof can be prepared. More specifically, in one aspect, an oil-based fluid polymer suspension (FPS) composition for use in oil or gas well servicing fluids is preferred containing: a) a hydrophilic polymer, b) an organophilic clay, c) a stabilizer, and d) a white medicinal oil having selected properties.

Canadian Patent Application No. 2506117, published Oct. 28, 2006, to Maskikewich et al., discloses a water based drilling fluid for shallow wells. The drilling fluid may include a blend of viscosifiers, fluid loss reducers, clay swelling inhibitors and “mud-ring” agents. This blend is in liquid form and is added to water to make drilling fluid for shallow well applications. The specification discloses that the viscosifier may be a water dispersible or soluble hydrophilic polysaccharide such as xanthan or guar gum or gellan gum, algin, locust bean gum, derivatized locust bean gum, carrageenan, derivatized guar gum, cellulosics such as carboxymethyl cellulose, hydroxyethyl cellulose, methyl cellulose and polyanionic cellulose, succinoglucans, polyacrylamides, starch and starch derivatives or mixtures of any of these components.

U.S. Pat. No. 7,347,265, issued Mar. 25, 2008, to Monroe, et al., discloses a method of forming temporary blocking gel containing guar derivative. A high temperature blocking gel contains a blend of an aqueous fluid and carboxymethyl guar and a crosslinking agent. The gel exhibits excellent hydration capability in brines and positive viscosity generation and controls fluid loss from an oil well during drilling, completion and/or workover operations.

All of the patents cited in this specification, are herein incorporated by reference.

However, in spite of the above advancements, there exists a need in the art for drilling fluids, drilling fluid additives, methods of making and using such fluids and additives, and methods of operating a well.

There also exists a need in the art for drilling fluids comprising guar, drilling fluid additives comprising guar, methods of making and using such fluids and additives, and methods of operating a well with a well fluid or additive comprising guar.

There even also exists a need in the art for drilling fluids comprising two or more guar compounds, drilling fluid additives comprising two or more guar compounds, methods of making and using such fluids and additives, and methods of operating a well with a well fluid or additive comprising two or more guar compounds.

There still also exists a need in the art for drilling fluids comprising two or more guar compounds having different viscosities, drilling fluid additives comprising two or more guar compounds having different viscosities, methods of making and using such fluids and additives, and methods of operating a well with a well fluid or additive comprising two or more guar compounds having different viscosities.

There also exists a need in the art for drilling fluids comprising guar and xanthan, drilling fluid additives comprising guar, methods of making and using such fluids and additives, and methods of operating a well with a well fluid or additive comprising guar and xanthan.

These and other needs in the art will become apparent to those of skill in the art upon review of this specification, including its drawings and claims.

### SUMMARY OF THE INVENTION

It is an object of the present invention to provide for drilling fluids, drilling fluid additives, methods of making and using such fluids and additives, and methods of operating a well.

It is even another object of the present invention to provide for drilling fluids comprising guar, drilling fluid additives comprising guar, methods of making and using such fluids and additives, and methods of operating a well with a well fluid or additive comprising guar.

It is still another object of the present invention to provide for drilling fluids comprising two or more guar compounds, drilling fluid additives comprising two or more guar compounds, methods of making and using such fluids and additives, and methods of operating a well with a well fluid or additive comprising two or more guar compounds.

It is yet another object of the present invention to provide for drilling fluids comprising two or more guar compounds having different viscosities, drilling fluid additives comprising two or more guar compounds having different viscosities, methods of making and using such fluids and additives, and methods of operating a well with a well fluid or additive comprising two or more guar compounds having different viscosities.

It is even still another object of the present invention to provide for drilling fluids comprising a guar compound and a xanthan compound, drilling fluid additives comprising a guar compound and a xanthan compound, methods of making and using such fluids and additives, and methods of operating a well with a well fluid or additive comprising a guar compound and a xanthan compound.

These and other objects of the present invention will become apparent to those of skill in the art upon review of this specification, including any drawings and claims.

According to one embodiment of the present invention, there is provided a method of producing a drilling fluid. The method may include blending an environmentally friendly oil with a viscosifier to produce a blended fluid. The viscosifier may comprises at least two different types of guar compounds. The method may also include contacting the blended fluid with water to produce a drilling fluid. Certainly the method may include blending water, viscosifier and the two types of guar compounds together in any suitable order.

According to another embodiment of the present invention, there is provided a well fluid comprising water, an environmentally friendly oil, and a viscosifier, wherein the viscosifier comprises at least two different types of guar compounds.

According to even another embodiment of the present invention, there is provided a method of operating a well comprising circulating a well fluid in the well, wherein the well fluid comprises water, an environmentally friendly oil, and a viscosifier, wherein the viscosifier comprises at least two different types of guar compounds.

### DETAILED DESCRIPTION OF THE INVENTION

The present invention finds applicability in a wide variety of well operations and well types, non-limiting examples of which include lost circulation, drilling regular diameter wellbores and drilling large diameter wellbores.

In lost circulation applications, viscosity is most important. In drilling, viscosity and fluid loss are important. In large diameter wellbores, low shear rate viscosity is important. In certain cases the blend of viscosifiers may need to be designed to perform better at higher temperatures. In high temperature formulations, stabilizing salts such as sodium sulfite and magnesium oxide could be a component. As a non-limiting embodiment, some formulations of the present invention are flexible in that magnesium oxide, sodium sulphite and/or certain other additives may be incorporated into the blend to extend the temperature stability and operating environment that the product can be effectively utilized in.

In some non-limiting embodiments, the present invention allows combination of number of chemical products into one package and may allow for rapid delivery of the chemicals to the drilling system, and in some embodiments improving chemical performance and reducing waste.

A blend of solids and liquids may be suspended in oil, which may be any type of environmentally friendly mineral oil, for rapid dispersion when added to water. This blend may include one or more of viscosifiers, a fluid loss reducer, surfactants to remove the oil from the solid particles, clay, pH control and “mud-ring” additives. The blended fluid of solids and liquids may be mixed together to form a suspension of solids in oil before addition to a water tank. As a non-limiting example, the blended suspension of solids in oil may be mixed in a mixing plant and stored in pails. It is then transported to the well site where it is added to the water in the tank at the drilling rig to make “drilling mud”. Simple agitation in the water tank produces a drilling fluid.

A non-limiting example of one embodiment of a suitable formulation is as follows:
Petroleum Distillate: 30-60%
Polysaccharide/natural polymers: 30-60%
Synthetic polymers: 10-20%
Surfactant, optional, and if present: 0.1-5%
Salts, optional, and if present: 0.1-5%
Boron salts, optional, and if present: 0.1-5%

The blend of solids and liquids are suspended in oil for rapid dispersion when added to water or some form of aqueous solution. This blend may include one or more of viscosifiers, a fluid loss reducer, surfactants to remove the oil from the solid particles, clay, pH control and a “mud-ring” additive. The blended fluid of solids and liquids may be mixed together to form a suspension of solids in oil before addition to a water tank (suction tank) at a well site. The fluid may be blended and stored, for example in a pail or other type of convenient of container, before adding to the suction tank to produce a drilling fluid. Agitation of the fluid in the tank causes rapid dispersion of the solid component in the water. The components added to the blend at a well site may be selected to match the requirements of the well. The system may be hauled to the next drilling location and used to drill surface hole. In this case, the alkalinity may be adjusted to make the system thick again, or otherwise adjusted as required.

The blend of solids and liquids may be suspended in a mineral oil or any environmentally friendly oil such as HT40N™ or HT30N™ from Petro-Canada of Calgary, Alberta, Canada, Amodril™ (from Amoco), Envirdril™ (from Shell), Drillsol™ (from Enerchem), Syndril™ (from SynOil Fluids), Biodiesel™ (from Bio-diesel Canada), Methyl canolate, Bayol™, Exxsol™ (from Exxon), Shellsol™ (from Shell), glycols, or vegetable oils such as canola oil or soya oil. The oil may be present in the range of from 30%, 31%, 32%, 33%, 34%, 35%, 36%, 37%, 38%, 39% or 40% to 45%, 46%, 47%, 48%, 49%, 50%, 51%, 52%, 53%, 54%, 55%, 56%, 57%, 58%, 59%, 60%, 61%, 62%, 63%, 64%, 65% by weight of the total blended fluid, for example 37% by weight. Non-limiting examples of suitable ranges include 30% to 60% and 35% to 50%. All weight percents are expressed as percentage of the total blended fluid. An environmentally friendly oil is an oil with a high flash point, readily biodegradable in the environment and safe to use from a human hygiene perspective (i.e. reduced amounts or contains zero concentrations of aromatic chemical components).

In some embodiments of lending the polymers into the mineral oil, high shear rates may be utilized. In some embodiments, blends may be formulated using in-line homogenizers.

The blended suspension may include viscosifiers. The viscosifier is present in the range of from 20%, 21%, 22%, 23%, 24%, 25%, 26%, 27%, 28%, 29%, 30%, 31%, 32%, 33%, 34%, 35%, 36%, 37%, 38%, 39% or 40% to 45%, 46%, 47%, 48%, 49%, 50%, 51%, 52%, 53%, 54%, 55%, 56%, 57%, 58%, 59%, 60%, 61%, 62%, 63%, 64%, 65% by weight of the total blended fluid, for example 35% by weight. Non-limiting examples of suitable ranges include 30% to 60% and 20% to 50%. All weight percents are expressed as percentage of the total blended fluid. The viscosifier may be 2, 3, 4, 5, 6, 7, 8, 9, 10 or more guar compounds. The guar compounds are generally different from each other. As a non-limiting example, the present invention contemplates a blending of guar types. As such, it may be possible to adjust the guar types and their concentrations to uniquely create products and synergies to respond to a variety of applications while improving net cost. The effectiveness of the blending of the guars allows for the real-time development of the desired fluid properties. In some non-limiting embodiments, the guar gums will differ by viscosity. If Xanthan is used, the xanthan may be present in the amount of 0.1%, 1%, 2%, 3%, 4%, 5%, 6%, 7%, 8%, 9%, or 10% by weight, and including any ranges between any two of those numbers, as non-limiting examples 1% to 10%, or 2%-5%. The guar may be unmodified or modified guar, and the xanthan may be Xanvis™ both available from numerous suppliers. Dril-Xpress is composed of a blending of guar types. As such, we are able to adjust the guar types and their concentrations to uniquely create products and synergies to respond to a variety of applications while improving net cost. The effectiveness of the blending of the guars allows for the real-time development of the desired fluid properties.

As a non-limiting embodiment, the viscosifying component may be a blend of Guar Gum polysaccharides. These could be derivitized guars such as HydroxyPropyl (HP Guar) or CarboxyMethyl (CM Guar) or CMHP Guar. High-viscosity, medium-viscosity or low-viscosity regular (natural, non-derivitized) Guar may also be used to enhance the viscosity and other various properties of the resultant fluid, depending on the performance requirements of that fluid.

In some embodiments a xanthan polysaccharide may be a component of the blend in those certain situations require the thixotropic properties, shear thinning properties, or the low shear rate viscosity of the fluid to be enhanced or modified.

Oil suspended guar systems in themselves are well known in the art, such as in U.S. Pat. No. 5,969,012, which is hereby incorporated by reference. In addition to comprising guar gum and optionally xanthan as previously mentioned, the viscosifier may further comprise other water dispersible or soluble hydrophilic polysaccharide such as or gellan gum, algin, locust bean gum, derivatized locust bean gum, carrageenan, cellulosics such as carboxymethyl cellulose, hydroxyethyl cellulose, methyl cellulose and polyanionic cellulose, succinoglucans, polyacrylamides, starch and starch derivatives or mixtures of any of these components. These may be present in the amount of 0.1%, 1%, 2%, 3%, 4%, 5%, 6%, 7%, 8%, 9%, or 10% by weight, and including any ranges between any two of those numbers, as non-limiting examples 1% to 10%, or 2%-5%.

In embodiments where low fluid loss slurries are required, polyanionic cellulose (PAC) or a blend of nonionic and slightly anionic derivatized corn starches may be utilized. In higher temperature applications, a hydroxylpropyl corn starch may in some embodiments be substituted to provide a lower fluid loss.

A fluid loss reducer such as Drispac™ available from chemical suppliers such as Canamara United in Calgary, Alberta, Canada may optionally be added to the blended fluid. When present, these fluid loss materials are generally present in an amount of 0.1%, 1%, 2%, 3%, 4%, 5%, 6%, 7%, 8%, 9%, 10%, 11%, 12%, 13%, 14%, 15%, 18% or 20% by weight, and including any ranges between any two of those numbers, as non-limiting examples ranging from about 5 to 15% by weight, for example 11% by weight.

Surfactants such as nonylethoxy phenol (for example, NEP-9™ available from Canadian Colors of Edmonton, Alberta, Canada to remove the oil from the solid particles, may optionally be added to the blended fluid in the amount of 0.1%, 1%, 2%, 3%, 4%, 5%, 6%, 7%, 8%, 9%, or 10% by weight, and including any ranges between any two of those numbers, as non-limiting examples ranging from about 2% to 5% by weight. The surfactants that work well in this application are specifically surfactants that emulsify oil in water; they are used to take the oil off the solids present in the mixture when the total mixture is added to water. Soda ash, which is commonly available, may be added to improve the hydratability of the guar by controlling the pH of the blend. pH controllers are primarily added to help the biopolymers viscosify faster in water. pH control of drilling fluid is well known in the art and need not be further described here.

Clay may be added as required, such as a bentonite, as for example SD-I™ available from Elementis, for example in the amount of 0.1%, 1%, 2%, 3%, 4%, 5%, 6%, 7%, 8%, 9%, or 10% by weight, and including any ranges between any two of those numbers, as non-limiting examples ranging from about 2% to 5% by weight or 1 and 4% of the total weight of the blended fluid. The organophilic clay is used to suspend solids in oil based products, that is to stop settling of the solids when sitting in a packaged form. Another supplier is Southern Clay. A non-limiting example of the order in which the solids may be added to the oil is first the clay, followed then by all the rest of the solids and liquids.

Additional viscosity can be achieved by using viscosifiers that can be crosslinked. Crosslinked bio-polymers can impart very high viscosities in short time periods. Suitable crosslinked bio-polymers are found in U.S. Pat. Nos. 6,642,185, 6,177,385, and 4,579,942, all herein incorporated by reference.

Benefits to the liquid suspension may with some embodiments include reduced mixing times. Some embodiments of the system require no mixing equipment (pumps and hoppers). As a non-limiting embodiment, the product may be added directly to the suction tank, above the agitator. Thus for some embodiments, less equipment may be required to mix products. With some embodiments, components disperse efficiently eliminating the “fish eye” and “clay ball” problem associated with conventional systems. Conventional clay based systems do not have time to hydrate and yield efficiently when drilling shallow wells, whereas in various embodiments of the present invention, components yield efficiently. All components are in one package, as for example a pail. For systems formulated with the product, it is possible to adjust properties for logging or circulating casing much more readily than with conventional systems. It also reduces the number of products to be managed (inventory and mixing) on the drilling location. Damage to inventory and inventory shrinkage of products will not occur to products in pails.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A method of producing a drilling fluid, the method comprising the steps of:
blending an environmentally friendly oil with a viscosifier to produce a blended fluid, wherein the viscosifier comprises at least two different types of guar compounds;
xanthan; and
contacting the blended fluid with water to produce a drilling fluid.

2. A well fluid comprising water, an environmentally friendly oil, and a viscosifier, wherein the viscosifier comprises at least two different types of guar compounds and xanthan.

3. A method of operating a well comprising circulating a well fluid in the well, wherein the well fluid comprises water, an environmentally friendly oil, and a viscosifier, wherein the viscosifier comprises at least two different types of guar compounds and xanthan.
